(19) United States
(12) Patent Application Publication
(10) Pub. No.: US 2009/0307212 A1
(43) Pub. Date: Dec. 10, 2009

(54) SYSTEM AND METHOD FOR EVENT MANAGEMENT

(75) Inventors: Arik Ramot, Tel-Aviv (IL); Alon Sudri, Tel-Aviv (IL); Omer Ben-Zeev, Tel-Aviv (IL)

Correspondence Address: MARTIN D. MOYNIHAN d/b/a PRTSI, INC., P.O. BOX 16446, ARLINGTON, VA, 22215, US

(73) Assignee: Hayoman ,Internet Technologies Ltd., Tel-Aviv (IL)

(21) Appl. No.: 12/373,302

(22) PCT Filed: Jul. 15, 2007
(86) PCT No.: PCT/IL2007/000886

§ 371 Date: Jan. 12, 2009

Related U.S. Application Data
(60) Provisional application No. 60/830,341, filed on Jul. 13, 2006.

(51) Int. Cl. G06F 17/30; G06F 15/16

(52) U.S. Cl. 707/5; 707/10; 709/206; 707/E17.014; 707/E17.032

(57) ABSTRACT

A cooperative scheduling system for cooperative scheduling between large numbers of independent users, the users being divided into a several interest groups, comprises: a networked server, a scheduling database associated with the networked server for storing scheduling data, the scheduling database allowing categorization of the data for the interest groups; a multi-user input interface for allowing multiple remotely located users to enter scheduling data to the scheduling database, the data being categorized for the interest groups; and a multi-user output interface for allowing multiple remotely located users to retrieve scheduling data from the scheduling database, the output interface including a configuration for filtering of the retrieval according to category. Thus scheduling data is stored at a central location in a cooperative effort and is retrieved according to the level of relevance to the user.

### RELATIONSHIP TO EXISTING APPLICATIONS

The present application claims priority from Provisional U.S. patent application No. 60/830,341, filed on Jul. 13, 2006, the contents of which are hereby incorporated by reference.

### FIELD AND BACKGROUND OF THE INVENTION

The present invention relates to a system and method for event management and, more particularly, but not exclusively to a system and method for collaborative event management via a networked location.

At the moment there is no calendar dedicated to specific sectors such as the business community, which relates to their specific events and needs. Most of the information regarding relevant events and dates is not available at all and the rest is scattered around the net and not organized in a clear, simple, easy to find and professional way.

There are currently a large number of web based platforms for private and public calendars. These provide platforms but neither the means nor the content for allowing communication or cooperation between different organizations.

Most of these sites enable the user to have his calendar on the web, share it entirely or partially with others, create group calendars and link their calendars with their organization or other web based sources of information. Some others enable open listings and sharing of mainly public events such as entertainment, sports and others.

None of these sites furnish a means for enabling scheduling type organization between independent entities. Such entities would like one reliable location to provide a dedicated solution.

A problem lies in there currently being no means to provide relevant well organized, easy and quick to find, constantly updated and personalized information. Such a lack has substantial financial, professional and social implications. Examples of situations not currently having an ideal solution are outlined hereunder.

A certain entity is preparing a large and expensive conference in a few months time. He wishes to be sure that on the same dates there is no competing event for the same professional group he intends to invite.

A certain user is preparing to spend a large amount on a wedding in five months time. He wishes to be sure that there is no major cultural or sports event that will prevent his intended guests from attending.

An accountant has heard that there is an interesting tax conference that he would like to attend but he does not know where to find it, what the program is or how to register.

A certain entity is organizing a conference and wishes to know well in advance how many people are going to attend so as to correctly handle all administrative issues. The problem is that most people make the decision regarding participation at the last minute. However one would like reliable data on at least those who are seriously considering coming. That is to say it would be helpful to know if people have in fact blocked the date even though they have not yet registered. It would further be useful to approach these people with real incentives to register.

A certain entity is preparing a grand opening of new modem offices and wishes the industry to know about it. The entity would like to invite colleagues, associates and clients and require a quick and simple attendance confirmation. This comes with the additional requirement of not wishing to spend huge amounts of effort and investment in locating the people, sending the material, publicizing the event and waiting for confirmation.

An entity wishes to maximize the yield of their marketing budget. One would very much like to approach people who, with very high probability, would need services. For example a travel agent may be interested in people who intend to attend a conference in a few months and would need flights and accommodation but have not yet taken the steps to buy or even look for such services.

### SUMMARY OF THE INVENTION

According to one aspect of the present invention there is provided a cooperative scheduling system for cooperative scheduling between a plurality of users, said users being divided into a plurality of interest groups, the system comprising:

a networked server,

a scheduling database associated with said networked server for storing scheduling data, said scheduling database further being configured to allow categorization of said data for said interest groups;

a multi-user input interface for allowing multiple remotely located users to enter scheduling data to said scheduling database, said data being categorized for said interest groups;

a multi-user output interface for allowing multiple remotely located users to retrieve scheduling data from said scheduling database, said output interface including a configuration for filtering of said retrieval according to category.

According to a second aspect of the present invention there is provided a method of cooperative scheduling comprising:

providing a networked scheduling location;

receiving scheduling data from a plurality of remotely located supplying users;

categorizing said scheduling data;

posting said scheduling data to said scheduling location;

supplying to remotely located retrieving users a filtering interface, said interface being responsive to said categorizing; and

allowing said remotely located retrieving users to retrieve scheduling data of interest from said scheduling location via said filtering interface.

According to a third aspect of the present invention there is provided a search engine configured with an events database in which each event has a time of occurrence, the search engine comprising:

a search module for searching said database for events in accordance with input search criteria and a calendarized output module configured to present output search results as items within a calendar display.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the Drawings:

FIG. 1 is a simplified diagram illustrating a system according to the present invention for cooperative scheduling configured for remote users over a network.

FIG. 2 is a simplified diagram illustrating the database manager and interfaces of FIG. 1 in greater detail.

FIG. 3 is a simplified flow chart illustrating a procedure for cooperative scheduling according to a preferred embodiment of the present invention.

FIG. 4 is a simplified use-case diagram for a guest user, according to a preferred embodiment of the present invention.

FIG. 5 is a use-case diagram for a user of type member, according to a preferred embodiment of the present invention.

FIG. 6 is a use-case diagram for a user of type provider, according to a preferred embodiment of the present invention.

FIG. 7 is an alternative use-case diagram for a user of type provider, according to a preferred embodiment of the present invention.

FIG. 8 is a use-case diagram for an administrator, according to a preferred embodiment of the present invention.

FIG. 9 is a simplified schematic diagram illustrating data objects to represent users and events, and the structural relationships between the events, according to a preferred embodiment of the present invention.

FIG. 10 is a simplified block diagram illustrating the layers of a system for cooperative scheduling, according to a preferred embodiment of the present invention, and showing how the layers provide access to different entities.

### DESCRIPTION OF THE PREFERRED EMBODIMENTS

The present embodiments comprise an apparatus and a method for a cooperative network based calendar or scheduling system, and a method of collaborative scheduling. The calendar may be web based and may be dedicated to specific sectors or communities having common interests.

Such a system is preferably updated simultaneously by a site manager or administrator and the users, and linked directly to the personal calendars of the various users.

Such a system jointly accommodates three different groups—the members of a specific sector, organizers of events for that sector and the suppliers of goods and services for that sector.

The system preferably includes a targeted and easy to use filter or search engine where users belonging to a given sector or community can get full and relevant information about upcoming events, a place where they add their own events and a platform for their personal calendar where such information can be organized, so that the users are able to obtain regular updates regarding their communities and furthermore are able to obtain information regarding choices that they have made or topics of specific individual interest.

Organizers of events who want to reduce the risk of the uncertainty regarding competing events, are able to obtain a platform where they can market their events in such a way as to be found easily by interested people. They are also able to obtain access to potential participants and have direct and constant contact with such people.

Furthermore, the suppliers of goods and services may have direct excess to people who may need their goods and services and maximize the return on their marketing expenditure.

Such a platform may enable users from each sector or community to find out quickly and easily and put on record events of interest to them according to sector, period, location, participants etc. Such users are able to list their own events in such a way that the details are available well in advance. Users may find out if there is any competing or interfering event at the date and time they wish to choose. Such users are subsequently able to obtain alerts in the event that a competing event is registered at a later stage. Such a platform enables a notification to all relevant parties of their event in a quick and easy way and thus allows immediate responses from the parties, and provides a direct link to and update of private or public calendars, including those of Outlook, Google, Yahoo etc.

The platform may further improve access to relevant services and merchandise associated with any event.

Embodiments of the present invention provide one of the first business applications for Web 2.0, meaning for cooperatively constructed sites on the web.

The principles and operation of an apparatus and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

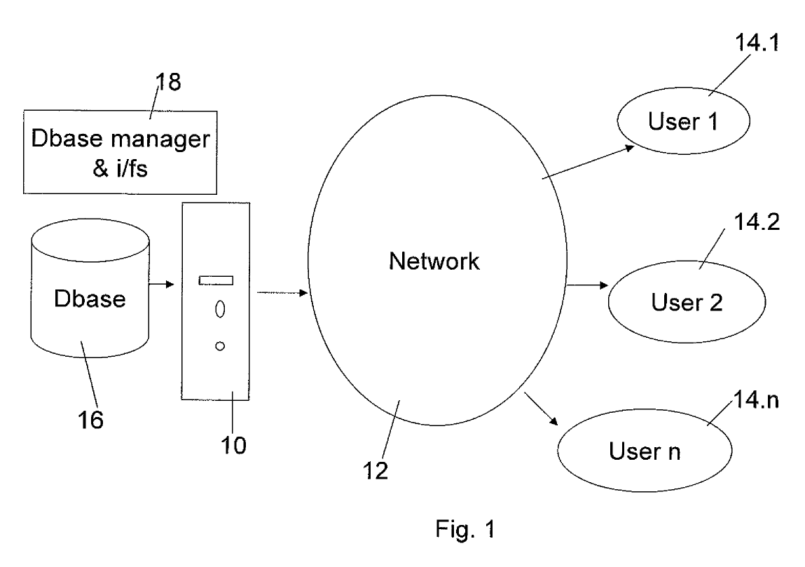

Reference is now made to FIG. 1, which is a simplified diagram showing a cooperative scheduling system for cooperative scheduling between large numbers of users according to a first embodiment of the present invention. The users are typically independent entities and can be divided into a plurality of interest groups. Typically the interest groups are business or professional interests of various kinds and the groups form communities based on their common interests. Users who are say involved in communications engineering may all be interested in engineering conferences that are to do with communications engineering. However, because they all work for independent entities there is currently no facility for them to carry out joint scheduling. The platform of the present embodiments solves the problem in that it provides for joint scheduling over a network so that interest groups can post and retrieve scheduled events over a network.

The platform comprises a server 10, connected via a network 12, such as the Internet or a cellular network, to multiple end users 14.1 . . . 14.n who connect via client devices such as cellular telephones or other computing devices. The end users wish to enter and retrieve scheduling information for their particular professional, business or other field of interest.

A scheduling database 16 is associated with the networked server 10, and stores scheduling data. The database is set up to categorize the scheduling data according to category and interest group, so that say information of interest to communication engineers is stored distinctly of information of interest to medical practitioners in general practice or of information of interest to tax advisers. A database manager and interface unit 18 provides interfacing, search and data management functionality to the database.

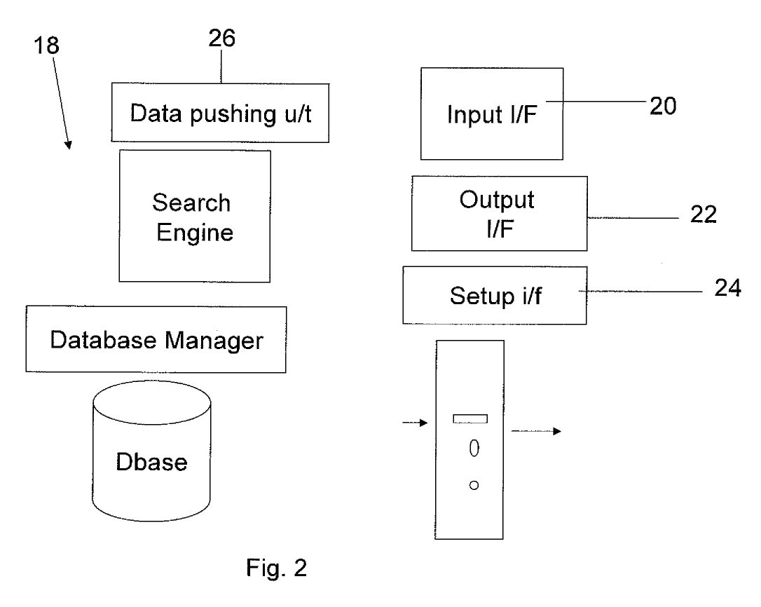

Reference is now made to FIG. 2, which illustrates the unit 18 in greater detail.

A multi-user input interface 20 allows multiple remotely located users to enter scheduling data to the scheduling database, so that the scheduling data is a collaborative effort within the purview of Web 2.0. The data may be categorized for the interest groups. The category is usually provided by the user through the interface, but it may alternatively be determined from the profile of the given user. Thus if the profile indicates that the user is a control engineer then the interface may assume that the scheduling data is within the field of control engineering. In one embodiment the assumption is displayed to the user by the interface for the user to confirm or deny. The user is free to add other categorization data as he feels appropriate.

A multi-user output interface 22 allows multiple remotely located users to retrieve scheduling data from the scheduling database. The output interface includes a filter which can be configured according to desired categories, or in the alternative may filter according to a user profile, so that a given user simply provides a profile, say on registration, and sees through the output a calendar with events already filtered for his declared interests. The output may be in the form of a calendar viewed on the user's screen, or may be in the form of text, a listing of events of interest. In a preferred embodiment the output unit works with the user's local calendar program, say Outlook Calendar, by Microsoft, and downloads the events directly into the user's calendar. The output unit may also work with calendar or organizer programs associated with mobile telephones or with other Palmtops and the like.

Preferably, the database is configured with predetermined categories, the categories being chosen to reflect the professional interests of the users of the facility. The categories may be arranged in a hierarchy. For example there may be a general category of engineering, suitable say for social events for engineers, or for administrative meetings of an engineering institution, and then more specific categories for the specific professional interests within engineering.

The database may of course be configured to accept additional user configurable categories. Thus a group of professionals may form a new interest group, and would even be able to introduce individual projects to the service. Thus say a new development project could be added as a category and all professionals involved in the project could add that category to their profile to see events associated with the project on their filtered calendar.

To the above end the user interface may include a user setup interface 24 to allow a user to indicate the various interests and categories that he has and also to add new categories to the system.

In addition to seeing events on a calendar, the users may wish to be told about events. To this end the server preferably includes a data pushing unit 26 for pushing to a user scheduling information of relevance to his indicated interest group. The data pushing unit may work with email, with text messaging or with any other suitable system for pushing data to users. Text messaging may be via Internet based messenger systems, or may use SMS for pushing data to mobile telephones via the cellular network. Data pushing may also be used for reminders or for information about products or services associated with the events.

The input interface and output interfaces themselves may be set up for working over the cellular network, so that a user can obtain an output display or output text via the cellular network.

As well as the output interface, the input interface may be set up to work with the personal calendar of a user, say to automatically accept events from a particular calendar. In this way an organization that regularly holds professional events may be able to keep the profession updated with the events automatically.

The input interface may include linking functionality for automatically linking in or receiving data from selected scheduling data sources, such as the above kinds of professional organization. The events themselves are uploaded to the calendar. In addition, data stored at the organization, such as background information about the event or the organizers, can be included via link on the calendar, as will be explained in greater detail below.

Preferably, a query-based search engine is also provided so that users can make active searches of the database using criteria of their own choice.

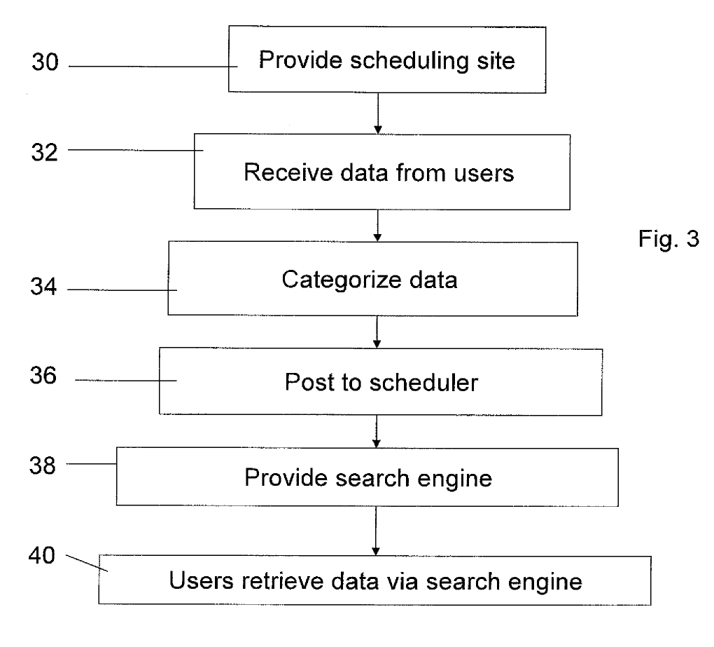

Reference is now made to FIG. 3 which illustrates the process of setting up and operating a cooperative scheduling system according to a preferred embodiment of the present invention.

A first stage 30 involves providing or setting up a networked scheduling location, which would typically be a server on a network, such as the Internet or cellular networks, arranged with a database which can be read and written to through its interfaces.

Once the site is set up then, in stage 32, the database receives scheduling data over the network from any users who wish to post details of events.

In stage 34 the data is categorized. As mentioned, possible ways for categorizing include the following:

to use profile data of the user who posts the information,

to use categories indicated by the user or organization who posts the information,

to automatically analyze the posted data and use logical rules to determine the categories, or

to have a site administrator manually categorize the data.

In one preferred embodiment several of the above methods are used together so as to arrive at optimal categorization.

Once categorized then the data is posted at the site in such a way that requesting users can view the information, stage 36. The data is then ready for viewing by other users.

Viewing is carried out using filters. Very few users would be interested in all the events on the calendar. Rather each user indicates the categories he is interested in and his view is filtered to include only those categories. Viewing may be direct at the site via a personalized web page. The web page is set up using the user's profile to show a calendar with the events of interest. Viewing may alternatively be by having the events of interest downloaded to the user's own personal calendar, as will be explained in greater detail below.

In addition the viewing users may optionally be provided with a search engine, stage 38, to search for events according to suitable criteria. In this case users retrieve event data via the search engine and the results may be displayed as a calendar-type display.

A web based calendar which caters for specific sectors and interests may be expected to create communities and provide a permanent crossroad for the thereby-created communities.

The site is preferably updated simultaneously by the site manager and the users, as explained and may be linked directly to their personal calendars. The site preferably offers all users a reliable and professional service.

The site preferably provides at least some of the following:
The user's personal calendar shows events based on his chosen group of interests including updates and alerts generated by the system, combined with his own personal events.
List of customized events which are all relevant to the user according to his chosen groups of interests but which he has not yet included in his calendar.
List, if required, of the current day events from all business fields, as well as major events from other fields such as: sports, music and politics, as per how the user chooses to set his filters. Thus ‘Show All Today's Events’ may be a setting provided with the filter.
Search area in which the user can change his groups of interests and search manually for other events based on dates, location and other categories.
Enter his own new event or message to be displayed and made available to other users according to his specific instructions.
Links to all sites displaying the details of all events, services and products.
Message board displaying messages and responses received from other users.
Discrete display of products and services specifically related to his chosen categories and events.
Professional dedicated forums and blogs for exchange of views and discussions.
Update of the user's personal calendar following the update of the site calendar.
The function of being a public calendar for groups with specific interests as explained above, also allowing users to share selected events of their personal calendars with other users.
Immediate alerts sent to the user by email or SMS or like alert services, regarding newly scheduled and/or competing events.

Upon entering the system the user obtains the following services:
He obtains a calendar showing his events based on his chosen group of interests including updates and alerts generated by the system.
List of customized events which are relevant to the user according to his chosen groups of interests and which have not yet been included in his calendar as well as major events from other fields such as: sports, music and politics.
A search engine dedicated to business events and thus guaranteeing quick and relevant results.
Update of the user's personal calendar with or without an update of the site calendar.
The site provides interactive links to source sites displaying details of events, services and products, and enabling registration and purchase of goods and services, as explained above.
Message board displaying messages and alerts generated by the system or third parties as well as relevant professional information.
The user is able to enter his own event to be displayed or sent according to his specific instructions or enter his private event for his eyes only, or to be announced only to users who have provided a given category indication.
Contact lists of participants in events, enabling the user to arrange meetings in advance and keep lists of relevant business contacts.

Discrete display of products and services specifically related to a user's chosen categories and events.
Professional dedicated forums and blogs for exchange of views and discussions.
Creating a public calendar of groups with specific interests or sharing a personal calendar with other users.

A means of drawing attention to or linking in professional material such as books, articles, lectures etc. related to a user's areas of interest.

Video screening of professional events, either live or from a well organized library, all related to such areas of interest.

The possibility of using a mobile phone to browse a user's private page on the site and get alerts via sms or mail as desired.

Sourcing and Inserting of Events

All events and relevant dates are preferably sourced and inserted in one of three ways—
By event organizers who may be provided with direct and uninterrupted access to the site, enabling them to publish their events and related messages.
From the Users, inserting their own events for their customers only or to the general public.
By the site manager from different available sources.

The above three sources are now treated in turn.

Sourcing from Event Organizers.

The scheduling site may be linked, through a dedicated web site, with event organizers receiving a constant stream of information that guarantees the relevance of the data on the site.

The event organizers have an obvious incentive to cooperate in order to publicize their events to an effectively targeted audience and direct customers to their own sites where they offer full information for registering for the events etc.

That is to say, the scheduling site is intended as a crossroads and a reference point for users and is not intended to compete with other sites, so that there is a joint interest for all parties to work together.

Sourcing from Users

Individual users are enabled to add their own new events to the scheduling site's data base. Once approved by the site management the system categorizes and displays the new events for all users. To prevent conflicting events, the users may have the possibility to check other events over the same period of time, category and fields of interest. The user may also publish events designated only for his clients or friends through the site, and such events are otherwise kept private, as explained above.

Displayed by Site Manager

The site manager may add information regarding events of general interest, as well as national and local holidays.

The database system itself provides a certain level of event management, in particular providing Metadata and Editing facilities for stored event items.

Sourcing and Inserting Events

Events and relevant dates may also be sourced and inserted directly from existing data bases on the net. Such databases may be linked to the site and the events may be inserted and updated automatically and/or manually.

Numerous relevant sources of events are displayed on web sites. The scheduling site of the present embodiments may be linked, with such sites receiving a constant stream of information that guarantees the relevance of the data on the scheduling site.

Typical kinds of sites to be linked are those of—
Conference and convention organizers
Import and export institutes.
Chambers of commerce and like associations.
The national and district Bar associations.
Auditors and accountants associations.
Associations of insurance brokers.
Associations of tax advisers.
Universities and other academic institutions
Stock exchanges.
Securities and Exchange Commissions.
Government offices.
Parliament, and political parties as well as political lobbying organizations.
The bankers association.
National banks and private banks.
Multinational accounting Firms.
Venture capital or like investment associations.
Forums for high tech CEO'S, and like managers' organizations.
International Engineering and scientific institutions and like professional bodies.
Traders' associations

Sourcing from Users

As explained above, any user may add a new event to the scheduling data base. The user, after being duly identified, may fill in the details of the events he wishes to add. The interface may provide him with a standard form for this purpose. The site's events information management may check the information furnished by the users so as to prevent abuse of the site. Once approved by the site management the system may categorize and display the new events for all users. To prevent conflicting events, the users may be provided with the possibility to check other events at the same period of time, especially those coinciding in terms of category and fields of interest.

Once the event is displayed a mail or other notification may be sent automatically to the user to confirm the posting. The user may also receive an alert by mail or sms in the case that there are conflicting events which are posted thereafter. What a conflicting event is may be defined by the user.

Displayed by Site Manager

The site manager is intended to constantly add information regarding general events such as cultural, political or other events of general interest, as well as national and local holidays.

The system may enable Metadata and Editing for its stored events items, as mentioned.

The system preferably includes an uploading mechanism for event items.

The system preferably includes an integration mechanism for receiving data from the providers and routing it into the system database.

The system preferably enables the extraction of detailed information in order to generate general as well as statistical reports.

The system preferably includes an automatic alert system to alert users by email or other alerting services regarding newly scheduled and/or competing events, as mentioned above.

The scheduling site of the present embodiments may be implemented as a Web application.

The scheduling web site is intended to be perceived by its users as a central location on which one can manage and control events of interest.

User inputs to the application would be:
Register to site
Edit profile
Search for events
Upload private events
Publish events
Alerts for newly scheduled and/or competing events as well as for marketing offers.

Site administration may in one embodiment be implemented via a Web-Form c# (asp.net) based tool that would give the site administrator the ability to:
Modify, approve or delete events items
Modify or delete (deactivate) members
Modify or delete (deactivate) providers
View site statistics
Configure the site labels for supporting multi languages infrastructure
Manage the site marketing banners

Database integration may be provided in one specific embodiment using a SQL-Server 2000 DTS (Data Transformation Service) based tool that would give the site integrator the ability to load bulk events data from the providers into the database.

Data mining may advantageously be provided by a database management application, for example a MS Access based application that would give the scheduling site managers and integrators the ability to:
Extract detailed information in order to generate general as well as statistic reports,
Export detailed information from the database into CSV or like files that are compatible with the users' personal diary programs.

Mail distribution may be provided by a 3^{rd} party mail distribution application that would give the scheduling site operators and integrators the ability to:
Send formatted, and even highly formatted, professional messages that are personalized for each promoted event, and
Prepare and schedule alert messages for delivery in response to business rules.

Various aspects of the API of the system are defined in table form below:

Partner→System CSV File Format

Site partners, meaning sites from which data and events are automatically transferred to the site preferably transfer the data as CSV formatted files to the site center. The file may contain the list of their published events.

The file data may be parsed and distributed directly to the system database.

The file format may follow the requirements set out in the following table:

TABLE 1
Partner → Site data transfer file format

| Field | Type | Mandatory | Description |
|---|---|---|---|
| EventUniqueID | Number | Yes | The event unique id which the |
| | | | provider has set. See constraint 1 |
| ProviderID | Number | Yes | Every provider will get an id |
| | | | number by the scheduling site |
| | | | center. |
| Title | Text (100 | Yes | The event title |
| | characters) | | |
| Description | Text (200 | No | A short description for the event. |
| | characters) | | |
| FromDate | Date and | Yes | When the event starts, the |
| | Time | | format should be: |
| | | | DD/MM/YYYY |
| | | | hh:mm. |
| | | | See constraint 2 |
| ToDate | Date and | Yes | When the event ends, the format |
| | Time | | should be: DD/MM/YYYY |
| | | | hh:mm. |
| | | | See constraint 2 |
| Link | Text (100 | Yes | Direct access to the event page |
| | characters) | | in the provider site for gaining |
| | | | full information, register etc. |
| Location | Text (100 | No | Where the event takes place. |
| | characters) | | |
| Categories | Text (100 | Yes | A string separated with comma |
| | characters) | | that holds the categories refer to |
| | | | this event. See constraint 3 |

Constraint:
1. Assuming every provider has a database in which he held his events item, every event will get a unique number. The scheduling site uses this number for updating (modify) the provider existing events that already written in the database.
2. DD=Day, MM=Month, YYYY=Year, hh=hour and mm=minutes.
3. Every provider may get a list of constant categories, for every event it is the provider's responsibility to set the categories relevant for the event.

An example of an event being provided is given in table 2:

TABLE 2
Event according to the format of table 1.

| Field | Data | Remark |
|---|---|---|
| EventUniqueID | 25 | |
| ProviderID | 10 | |
| Title | Taxes in real estate for auditors | |
| Description | A short description | |
| FromDate | 01/01/2006 09:30 | |
| ToDate | 01/01/2006 12:00 | |
| Link | http://www.site.com/id=25 | The direct link |
| | | for this event |
| Location | Dan hotel, Tel Aviv | |
| Categories | 1, 4, 10 | 1 = Taxes |
| | | 4 = Real estate |
| | | 10 = accounting |

In the following is provided a user-based model. In the model we distinguish between different types of users:

Guests—Refers to all non registered users of the site.

Members—Refers to registered users, who receive a higher service level than guests.

Provider—Refers to registered users who can publish their events to the site.

Administrator/Integrator/Operator—Refers to the site users who manage the system through the management applications.

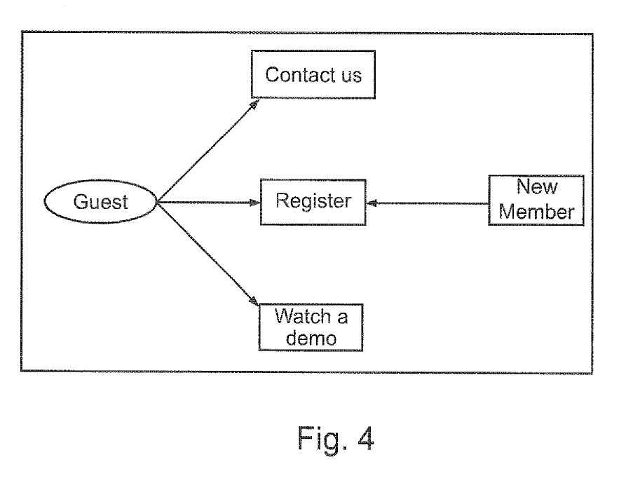

FIG. 4 is a simplified use-case diagram indicating the use case of a guest user connecting to the site, and showing the different operations that may be implemented:

Guest

Register

Contact us

Watch a demo

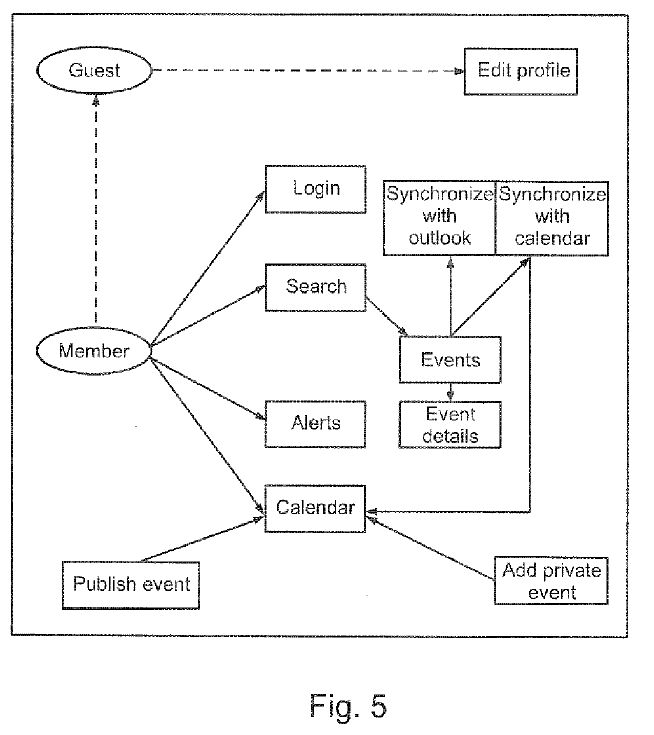

FIG. 5 illustrates the use case of an already registered site member connecting to the site, and illustrating the operations that are available for implementation. To understand the diagram it should be borne in mind that the features of the guest are already incorporated, as implied by the inclusion of a guest item in the diagram.

Member

Contact us

Watch a demo

Login

Edit user profile and set the fields of interest

Search for events

Events panel

Synchronize events with the site calendar

Synchronize events with the outlook calendar

Event details

The site calendar

Add a private event to the calendar

Publish event

Exposure to system alert and focused marketing proposals.

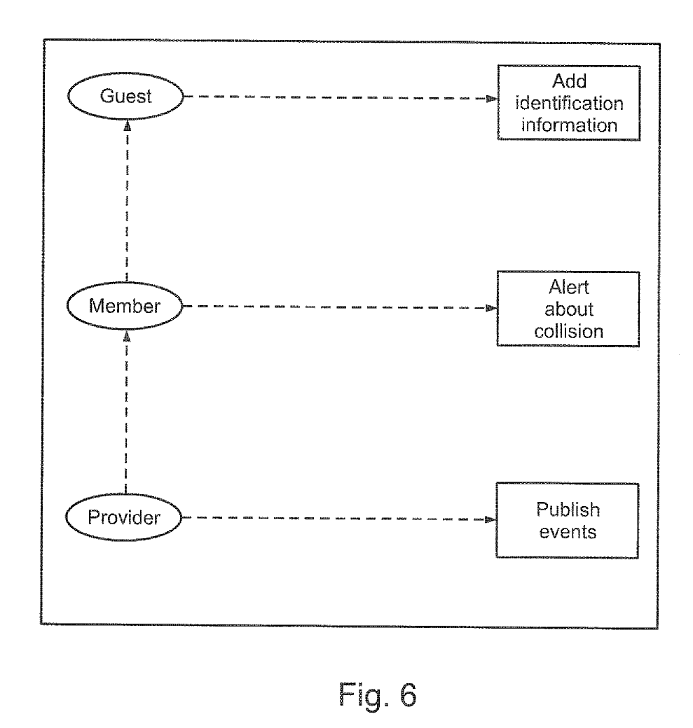

Reference is now made to FIG. 6, which is the provider use case diagram.

The provider use case diagram includes all the features of the guest and the member with one further feature, that of automatic publishing of events. The specific list of operations available for implementation in the case of a provider is as follows:

Contact us

Watch a demo

Login

Edit user profile and set the fields of interest

Search for events

Events panel

Synchronize events with the site calendar

Synchronize events with the outlook calendar

Event details

The site calendar

Add private event to the calendar

Publish an event

Add additional identification information

Exposure to system alert and focused marketing proposals

Notify, by email, about events that will publish in his event timeframe

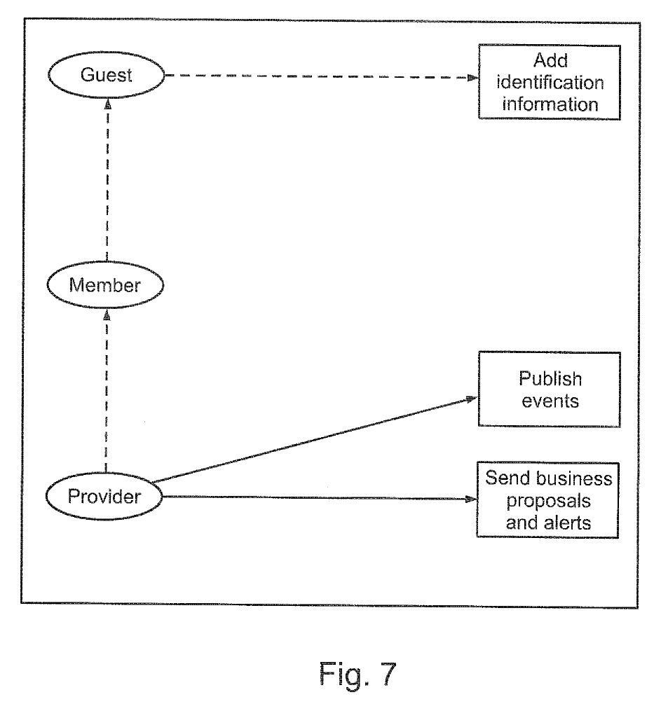

FIG. 7 is an alternative use case diagram for the provider adding explicitly the operation of sending business proposals and alerts. Thus the provider user is provided with a higher level of service.

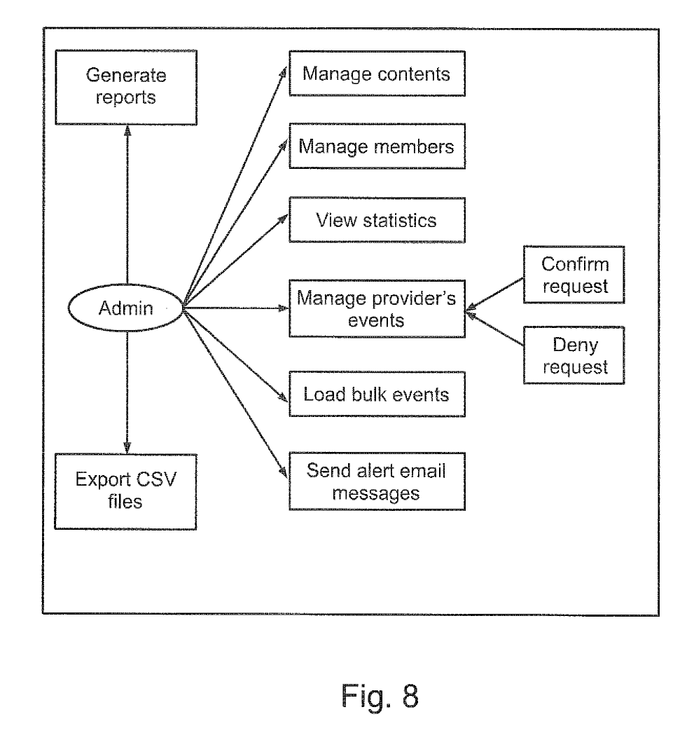

FIG. 8 is a use case diagram for the scheduling site operator or administrator. The administrator is able to implement the following:

Manage content

Manage members

Manage statistics

Manage providers' events

Manage the site marketing banners

Load bulk event data

Generate reports

Export detailed information to CSV files

Send alert email messages

A sample of the use-cases are now explained in greater detail, beginning with the case of Guest—Register.

Purpose: registration to the site.

Actors: Guest.

Overview: The user fills a registration form and submits the completed form to the server. The server then creates an entity of the requested type.

The registration form may include the following fields:

1. user name

2. password

3. confirm password

4. full name

5. email

6. I have read and confirm the site terms and condition

7. Remember my ID on this computer

Pre-condition: the user has filled in all required fields in the registration form.

Post-condition: once the user is registered and his account is activated, the user can login to the site as a member etc.

TABLE 3
User Login Event flow

| User & Client Side Action | System Actions |
|---|---|
| 1. User fills registration form and | 2. The server handles the registration |
| submits | request. |
| 3. The user logs in to the system | |

A second event case that is considered is member/provider-search for events

Name: Search for events

Purpose: Search events, the output provides a list of event items.

Actors: Members and Providers.

Overview: the system presents to the user a search engine based which can search using any of the following:

Alphabetic pattern

Filter by fields of interest

Filter by date range

Filter by location

Filter for events that the user has marked in the past

The user selects his search parameters and receives a set of results ordered by date ascending, and can then proceeds to handle the events result set.

Pre-condition: user logged in.

Post-condition: event results are displayed.

Table 4 below shows the flow of events for the search.

TABLE 4
Event flow for Search

| User Action | System Actions |
|---|---|
| 1. User enters search parameters. | 2. System handles search request and |
| | returns resulting items. |

Another event of interest is display of the events panel to a given user.

Name: Events panel

Purpose: displaying the events table. A table with the following columns:

The event field of interest

The event date

The event title

Actions:

1. Add to/remove from the site calendar

2. Synchronize with the outlook calendar

The table may be sorted to ascend by the event date, or any other suitable way of sorting may be selected.

Actors: Members and Providers.

Overview: There are two situations in which the user exposes this panel:
1. When the user logs in to the site, he may get a panel of events related to his chosen field of interest.
2. When the user uses the search engine.

In both cases the table will look and act as follows.

Every row (i.e. event) has a special column painted in the color of the related field of interest—pressing on this row leads to the event details page.

Events that the user chooses to mark as interesting will display in bold fashion while the user has the ability to synchronize it with his own personal calendar or remove it from the site calendar.

Events that the user does not choose to mark as interesting or new events will display in regular fashion while the user may have the ability to add it to the site calendar.

Pre-condition: user logged in.

Post-condition: event table are displayed.

A typical flow of events is shown in table 5 below:

TABLE 5
Event flow in the event table display case

| User Action | System Actions |
|---|---|
| 1. User move the mouse over the row | 2. A tool tip with the event short |
| | description will be shown |
| 3. User click the row | 4. The event details will be shown |
| 5. User click on the synchronize with | 6. The event will added to the user |
| outlook calendar button | outlook calendar |
| 7. User click on the add to the site | 8. The event will be added to the |
| calendar button | site calendar |
| | 9. The row text will change to bold |
| 10. User click on the remove from | 11. The event will be removed |
| the site calendar button | from the site calendar |
| | 12. The row text will change to |
| | regular |

The use case of member or provider synchronizing with the site calendar is as follows:

Name: Synchronize with the site calendar

Purpose: add/remove event from the site calendar.

Actors: Member and Provider.

Overview: the user can add or remove events from his private calendar; this can be done from the action button that is part of the events panel.

Pre-condition: user has logged in

Post-condition: the site calendar is be changed accordingly.

TABLE 6
Synchronizing with the site calendar

| User & Client Side Action | System Actions |
|---|---|
| 1. User click on the add to the site | 2. The event will be added to |
| calendar event panel action button | the site calendar |
| 3. User click on the remove from the site | 4. The event will be removed |
| calendar event panel action button | from the site calendar |

We now consider the use case of synchronizing the site calendar with the user's personal calendar.

Name: Synchronize with the personal calendar

Purpose: add event to the outlook calendar.

Actors: Member and Provider.

Overview: users with a compatible personal calendar are provided with the ability to add a given event to their personal calendar.

Pre-condition: user has logged in

Post-condition: a new entry will be added to the personal calendar

The use case of viewing event details is as follows:

Name: Event details

Purpose: display information about an event

Actors: Member and Provider.

Overview: when a user clicks on an event panel row or when he clicks on an event indicator on his private calendar he is led to a detail page.

In the detail page he obtains additional information about the event including the title, description, dates, location and provider.

There are actions he can perform such as:

Link to provider event page where he can register to the event.

Add the event to his private calendar

Add the event to his personal calendar

Mark the event as registered at the provider site

Seek for a marketing proposal or like business activity in reference to the event

Send the event to a friend

TABLE 7
Synchronizing the site calendar with the user

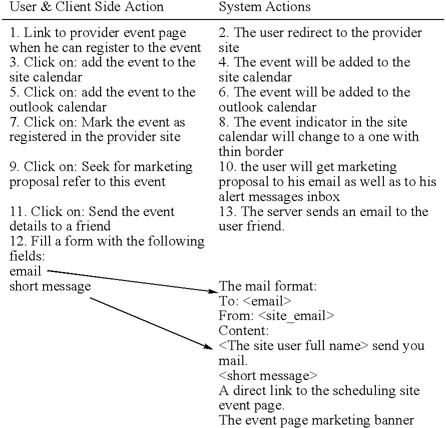

The following is the use case of display of the user's private version of the site calendar. Note the user's private calendar is a filtered version of the site calendar, as opposed to the personal calendar, which is the user's own calendar to which certain events may have been downloaded.

Name: The site calendar

Purpose: display the user private calendar

Actors: Member and Provider.

Overview: When the user logs in to the site, he obtains a calendar display.

The month view calendar contains in each cell, representing a day, indications about events that the user chooses to mark. The indications may be in the form of a small square with a color matching that of the field of interest.

There may be provided two types of indications. Possible implementations of distinctive indications are:
1. A small square with no border, indicating that the user chooses only to mark this event.
2. A small square with thin border, indicating that the user chooses to mark and register to the event at the provider site.

As the user moves the mouse over the indicator, a tool tip with the event date and title may usefully be displayed, and to lead to the event detail page.

The following is a description of the procedure for adding a private event to the calendar:

Name: Private events

Purpose: add private events to the site calendar

Actors: Member and Provider.

Overview: The user will have the option to add a private event or notification into the site calendar.

The user fills an event form and submits to the server, the server then adds the event to the database and updates the site calendar.

The event form includes the following fields:

1. title

2. start date and time

3. end date and time

1. location

The publishing of an event by an event provider may be implemented as follows:

Name: Publish an event

Purpose: The provider level member has the option to publish an event.

Actors: Provider.

Overview: This process includes the following steps:
1. The user fills an event form and submits it to the server.
   The event form includes the following fields:
      title
      description
      start date and time
      end date and time
      a link, for example: a link directly to the event page, link to the user web site or the user email
      location
      the event fields of interest
2. The user may be informed about collisions in a given time frame, for example a week before and after the chosen date.
3. The server may route the event to the site operator for observation and if the event matches the site criteria, the event may become available for all the site members.

The user may also be provided with the option to publish an event.

Actors: Provider.

This process includes the following steps:
1. The user fills a provider form and submits to the server.
   The provider form includes the following fields,
      name
      occupation
      phone
      mobile phone
      firm name
      firm address
      firm phone
      firm web site
2. The user fills an event form and submits it to the server.
   The event form includes the following fields:
      title
      description
      start date and time
      end date and time
      location
      link directly to the event page
      link directly to the registration page
3. Bound fields of interest to the event
4. The user is informed about collisions in a time frame, say a week before and after the chosen date.
5. The server routes the event to the operator for observation and if the event matches the site criteria, the event will be available for all the site members.

The user alerts mechanism is now considered:

Name: The user alerts mechanism

Purpose: inform the user about site activities which match his preferences.

Actors: Member and Provider.

Overview: After the user logs in to the site, the server checks the user preferences and scans the database. The user obtains a notification about alerts currently in his alerts inbox.

There are three types of alerts:
1. The user has marked an event, which was subsequently rescheduled,
2. User chooses to get marketing offers relating to a certain event
3. The user who published an event, may be informed about new events in his event time frame, especially if they share categories.

Pre-condition: user has logged in.

Post-condition: none.

Email notifications are essentially the same but are sent directly to the user.

The system is able to download to the site bulk event data, say from organizations. Such an operation may be implemented as follows:

Name: Load bulk event data

Purpose: enable the site administrator to import CSV files into the database

Actors: Administrator

Overview: The administrator points to a local CSV file and submits it to the server. The server parses and distributes the data into the database.

Another operation of interest is the sending of alert messages.

Name: Sends alert email messages

Purpose: Interact with the users

Actors: Administrator

Overview: Administrator logs into the mail distribution software.

The administration has the following options:
1. Send highly formatted professional messages that are personalized for each promoted event
2. Prepare and schedule alert messages for delivery in response to strictly business rules

Such an operation may also be scheduled automatically, say at intervals of a week before and a day before an events all users who have marked the event are sent an email reminder.

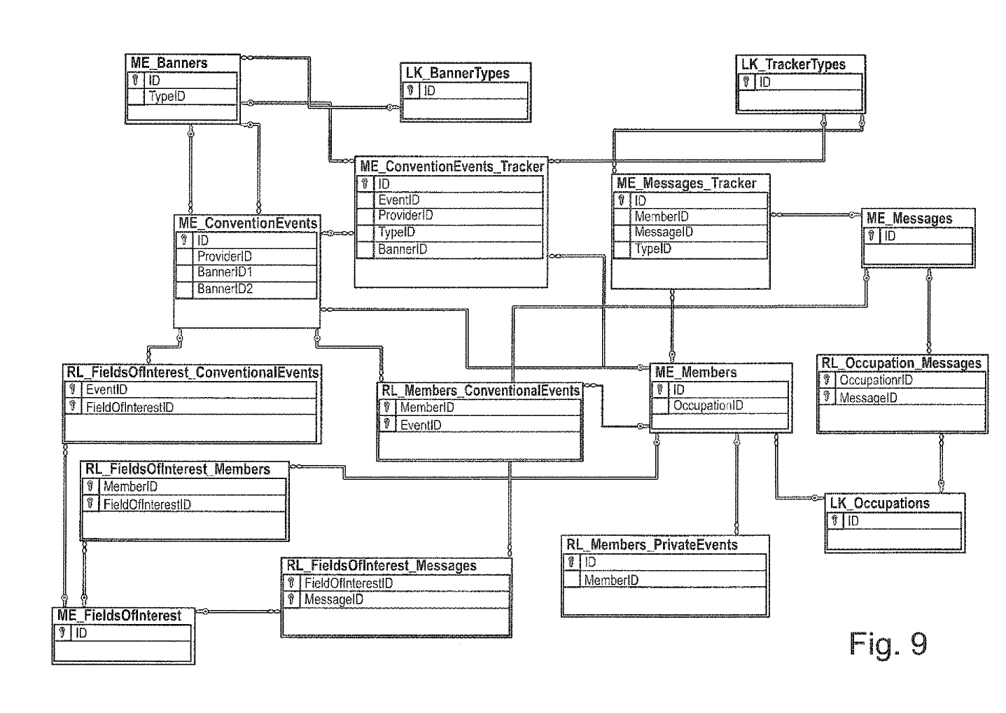

A list of possible data objects is now given. Their hierarchy is shown in FIG. 9. The following is a partial list of the data objects in FIG. 9.

ME_Convention Events—this data object refers to the site public events.

ME_Members—this data object refers to registered users.

ME_Member_Private-Events—this data object refers to member private events.

ME_Member_convention_Events—this object refers to member convention events.

ME_Fields_of_interest—this data object refers to the list of fields of interest.

ME_Banners—this data object refers to site banners.

RL_Member_Convention_Event—this data object refers to the relationship between the ME_Members and ME_Convention_Events, meaning, a member can be attached to more than one event.

RL_Fields_of_interest_members—this data object represents the relationship between the ME_Members and ME_Field_of_interest, meaning, a member can have more then one field of interest.

RL_Fields_of_interest_convention_event—this data object refers to the relationship between the ME_Convention_Events and ME_Field_of_interest. Thus, an event can be related to more than one field of interest.

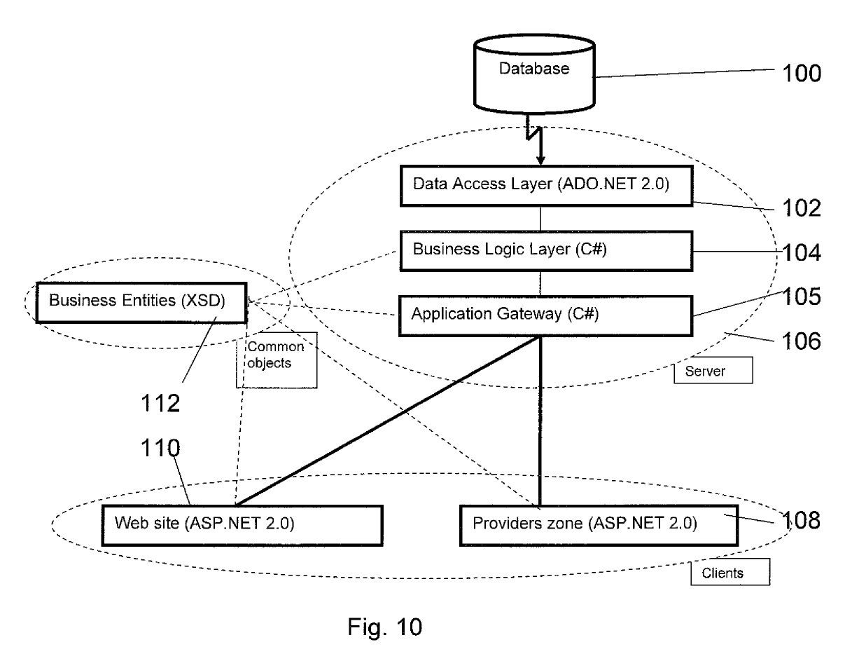

Reference is now made to FIG. 10, which is a simplified schematic diagram showing different layers that may be involved in a cooperative scheduling site according to the present embodiments. Database 100 is accessed via a database access layer 102, a business logic layer 104 and an application gateway 105. The database and its access means are located on server 106. Clients enter though a web site application 108, or if they are approved event providers then through provider zone 110. The provider zone is discussed in greater detail below. Business entities 112 enter the business logic or application gateway directly or enter the web site application or the providers' zone.

Statistical Analysis of Usage

The user is not merely exposed to those events of his chosen fields of interest. He may be interested in knowing which events are of interest to others. He may for example wish to advertise with or sponsor an event with the potential to give him a large exposure. Alternatively he may simply wish to know whether there are many other users in a category in which he is considering posting an event.

Such may be achieved as follows:

The system is able to obtain statistics for every event and for every type of exposure of the event to a user.

Every type of exposure obtains a score—

TABLE 8
Scoring for Exposures

| Type of exposure | Score |
|---|---|
| Exposure includes provider web site link | X |
| Click on the provider web site link | 2X |
| Expose to the provider proposal message | 1.5X |
| Click on the provider proposal message | 3X |
| Click on event details link | 5X |
| Click on registration form link | 10X |

When the user logs in to the application a calculation may be made as follows:

1. obtain all the tracking information referring to the user in the past 6 months

2. for each event:
a. obtain the related fields of interest
b. summarize the score

3. summarize the total score by field of interest

A matrix with fields of interest and aggregated score may then be produced.

A field of interest in which the aggregated score is less then a certain threshold may be ignored.

Finally, the user may wish to obtain the X top score fields of interest and seek business proposals related to those fields of interest, or those events. An advertiser may be able to select the events with higher levels of interest to advertise in, and an owner may note the level of interest in order to modify the advertising fee.

Note that a user may obtain business proposals and alerts by fields of interest that he did not mark but that the system has identified as being of interest due to the tracking. That is to say the user will receive guidance on placement say of his advertising to increase his exposure if this is of interest.

The system may be provided with a feature known as the providers' zone which is intended to assist event providers.

The providers zone allows event organizers to insert data directly into the events data base.

The providers zone may be implemented as a web application system.

The providers zone may be a secured system, say using SSL encryption technology, to prevent access from unfriendly entities who might damage the data base etc.

The providers' zone may be implemented as an individual stand alone system which users can enter from all stations.

Once an event provider is determined to be suitable based on his content and is seen to be reliable, he is provided with a personal user name and password to access his new account in the providers zone.

The providers zone preferably behaves like a back end content management system for the event providers, and allows each provider to insert his events through his own personal and secured gate.

Eventually all events from all providers are centralized in one public data base that is available for the end users.

The site manager preferably receives an automatic email with the event description each time an authorized provider inserts an event to make sure the contents are not harming or insulting.

The administrator is preferably provided with full access to the providers zone, for both QA and support to each account of all authorized event providers.

An advantage conferred by the providers' zone is that, the authorized event provider does not have to wait for site administrator to insert his events into the public data base.

The event is preferably inserted automatically and at the same time, a mail is sent to the administrator as explained.

The providers zone may include the tools to make sure events providers can always update, modify and promote their events.

The event providers are preferably enabled to send business proposals and messages to end users.

A collisions search allows a posting user to check for the best date to publish his upcoming events, as mentioned above.

Use of the collision search involves a user typing a date. The system then sends a list of the events occurring one week after and one week before the requested date.

Such an option helps the user understand and decide on the best date for events. Using the collision search allows a user to see if other providers had already published events related by content and make the right decision accordingly.

The user is able to navigate between the following pages: Entrance page, Publishing Events page, Contradictions page and My events page. The user can also save, refresh, see the terms and conditions and add the providers zone web address to his favorites.

The My events page allows a user to supervise the events already published in the data base. The page displays an event list for both historic and upcoming events of the current user account.

When clicking on one of the table rows, a pop up window may appear in which the user can modify the event details, and change the fields of interests the event was related to.

The user can also promote his events by adding business proposals to any of his upcoming events.

Once the user inserts a business proposal it may then be displayed inside the cooperative scheduling web site in two different places.
Inside the event detail window a short sentence describing the proposal may appear with a link referring directly to the source web page in which the end user can find more details and contact the provider.
When end users add an event with a business proposal inside their favorites list, a new message may appear inside a messages and proposals box. A new proposal message will be displayed as before.

When necessary, a user may send a message indicating a change in the event details.

Changes in places, dates or hours may be displayed in the same way that business proposals are displayed for end users, both inside the event details window and inside the messages and proposals box, and indeed the system mailer preferably displays relevant contents for all registered users.

The system may pull updates for each recipient, according to a personal profile or by taking settings from the user's filtering system.

The content sent to registered users comprises updates according to his fields of interests, and may further include banners and business proposals.

In an embodiment, the end user obtains a collection of links organized into one personal email.

The links may for convenience be organized into groups such as:

Updated events

New messages and Business proposals

Business proposal

Banner

Both Business Proposals and the banner refer end users to the providers' original websites where all relevant details are presented.

A Users and Fields of interests module may be provided to show the relation between the end users and the different fields of interests. Sixty is a typical number for suitable granularity of fields of interest, and the module shows the number of end users for each field of interest.

A module may be provided to show user occupations. Such a module may indicate the number of end users for each occupation.

As well as the sixty categories there may be a similar number of fields of interest and events may be placed under fields of interests. A module may be configured to show the number of events under each one of the sixty fields of interests, or for that matter under each category.

An Events Organizers and Events module may be configured to provide a list of events provided by organizers with accounts in the Providers Zone.

A list of events is displayed for each event organizer, and the event details may be presented in an edit mode for modifications and correction if needed.

In addition to the event details, tracking data results are displayed for each link to track events in which end users were transferred to either organizers web sites or third party providers.

The system preferably measures both exposure and clicks made by end users for each link and for banners.

For each event there is data about the number of end users who have chosen to register or include the event in their own list.

The business proposals and messages for each event are also displayed in edit mode to let the system administrator modify or correct under the permission of the organizers and third party providers.

An End User Management and Surveillance module may be configured to allow system administrators to check on the registered end users details. Through the module, a system administrator can recognize, contact and assist registered users of any kind or even a third party provider.

The system may display a total list of all the registered members.

The list may be searched using the following options:

Quick search: Under a Quick search option there are modules as follows:

Registered Members by Email:

This option lets a system administrator search all registered members whether end users, event organizers or third party providers by their email address.

This option is useful since the email address acts as the unique key for each member. Therefore, the best way to trace a member is by first locating his email address.

Registered Members by Company Name:

This option allows an administrator to trace a member by typing the name of his organization. This option is useful when trying to find details about event organizers and third party providers.

Events by ID Number:

Each event inserted inside the public database receives a unique ID number. The system administrator can use the ID number to trace back to the event or event to the posting user.

Events by Title:

Events may be traced by typing their names, that is the event title.

This option is useful when the request comes from the event organizer who usually does not know the unique ID numbers for his published events.

It is expected that during the life of this patent many relevant devices and systems will be developed and the scope of the terms herein, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A cooperative scheduling system for cooperative scheduling between a plurality of users, said users being divided into a plurality of interest groups, the system comprising:
a networked server,
a scheduling database associated with said networked server for storing scheduling data, said scheduling database further being configured to allow categorization of said data for said interest groups;
a multi-user input interface for allowing multiple remotely located users to enter scheduling data to said scheduling database, said data being categorized for said interest groups;
a multi-user output interface for allowing multiple remotely located users to retrieve scheduling data from said scheduling database, said output interface including a configuration for filtering of said retrieval according to category.

2. The cooperative scheduling system of claim 1, wherein said database is configured with predetermined categories.

3. The cooperative scheduling system of claim 2, wherein said database is configured to accept additional user configurable categories.

4. The cooperative scheduling system of claim 1, wherein said database is further configured with a user setup interface to allow a user to indicate his interest group.

5. The cooperative scheduling system of claim 4, wherein said server comprises a data pushing unit for pushing to a user scheduling information of relevance to his indicated interest group.

6. The cooperative scheduling unit of claim 5, wherein said data pushing unit comprises email functionality for pushing said scheduling information as an email.

7. The cooperative scheduling unit of claim 5, wherein said data pushing unit comprises text messaging functionality for pushing said scheduling information as a text message.

8. The cooperative scheduling unit of claim 5, wherein said data pushing unit comprises cellular communication functionality for pushing said scheduling information via a cellular network.

9. The cooperative scheduling unit of claim 1, wherein at least one of said input interface and said output interface comprises cellular interface functionality for interfacing across a cellular network for said scheduling data.

10. The cooperative scheduling unit of claim 1, wherein at least one of said input interface and said output interface is configured to exchange data with a personal calendar of a respective remote user.

11. The cooperative scheduling unit of claim 1, wherein said input interface comprises linking functionality for automatically receiving data from preselected scheduling data sources.

12. The cooperative scheduling unit of claim 1, wherein said configuration for filtering of said retrieval further comprises a search engine.

13. The cooperative scheduling unit of claim 1, further comprising a learning unit, configured to learn additional interests of a user from actual usage by said user.

14. The cooperative scheduling unit of claim 13, wherein said actual usage is network usage outside of said scheduling unit.

15. The cooperative scheduling unit of claim 1, further comprising an event interest measuring unit configured for measuring interest by users in a given event.

16. The cooperative scheduling unit of claim 15, wherein said event interest measuring unit is configured to assign different levels of interest to different parts of an event notification and to score said interest according to user interaction with said different parts.

17. A method of cooperative scheduling comprising:
providing a networked scheduling location;
receiving scheduling data from a plurality of remotely located supplying users;
categorizing said scheduling data;
posting said scheduling data to said scheduling location;
supplying to remotely located retrieving users a filtering interface, said interface being responsive to said categorizing; and
allowing said remotely located retrieving users to retrieve scheduling data of interest from said scheduling location via said filtering interface.

18. A search engine configured with an events database in which each event has a time of occurrence, the search engine comprising:
a search module for searching said database for events in accordance with input search criteria and
a calendarized output module configured to present output search results as items within a calendar display.
